(19) United States
(12) Patent Application Publication
(10) Pub. No.: US 2008/0305284 A1
(43) Pub. Date: Dec. 11, 2008

(54) Inkjet Recording Element

(76) Inventor: Olivier J. Poncelet, Chalon-Sur-Saone (FR)

Correspondence Address: EASTMAN KODAK COMPANY;PATENT LEGAL STAFF, 343 STATE STREET, ROCHESTER, NY, 14650-2201, US

(21) Appl. No.: 11/570,898

(22) PCT Filed: Jun. 13, 2005
(86) PCT No.: PCT/EP05/06307

§ 371 Date: Dec. 19, 2006

(30) Foreign Application Priority Data
Jul. 8, 2004 (FR) 0407561

(51) Int. Cl. B41M 5/00

(52) U.S. Cl. 428/32.1

(57) ABSTRACT

The present invention relates to an inkjet recording element having good stability to light and ozone over time. Said recording element comprises a support and at least one ink-receiving layer, said ink-receiving layer comprising at least one hydrosoluble binder and at least one fibrous aluminosilicate polymer obtainable a preparation method consisting in a controlled hydrolysis of aluminum halide and silicon alcoxide, and in a heat treatment in the presence of silanol groups for sufficient time to form the fibrous aluminosilicate polymer.

### FIELD OF THE INVENTION

The present invention relates to an inkjet recording element.

### BACKGROUND OF THE INVENTION

Digital photography has been growing fast for several years and the general public now has access to efficient and reasonably priced digital cameras. Therefore people are seeking to be able to produce photographic prints from a simple computer and its printer, with the best possible quality.

Many printers, especially those linked to personal office automation, use the inkjet printing technique. There are two major families of inkjet printing techniques: continuous jet and drop-on-demand.

Continuous jet is the simpler system. Pressurized ink (3.10⁵ Pa) is forced to go through one or more nozzles so that the ink is transformed into a flow of droplets. In order to obtain the most regular possible sizes and spaces between drops, regular pressure pulses are sent using for example a piezo electric crystal in contact with the ink with high frequency (up to 1 MHz) alternating current (AC) power supply. So that a message can be printed using a single nozzle, every drop must be individually controlled and directed. Electrostatic energy is used for this: an electrode is placed around the inkjet at the place where drops form. The jet is charged by induction and every drop henceforth carries a charge whose value depends on the applied voltage. The drops then pass between two deflecting plates charged with the opposite sign and then follow a given direction, the amplitude of the movement being proportional to the charge carried by each of them. To prevent other drops from reaching the paper, they are left uncharged: so, instead of going to the support they continue their path without being deflected and go directly into a container. The ink is then filtered and can be reused.

The other category of inkjet printer is drop-on-demand (DOD). This constitutes the basis of inkjet printers used in office automation. With this method, the pressure in the ink cartridge is not maintained constant but is applied when a character has to be formed. In one widespread system there is a row of 12 open nozzles, each of them being activated by a piezo electric crystal. The ink contained in the head is given a pulse: the piezo element contracts with an electric voltage, which causes a decrease of volume, leading to the expulsion of the drop by the nozzle. When the element resumes its initial shape, it pumps into the reservoir the ink necessary for new printings. The row of nozzles is thus used to generate a column matrix, so that no deflection of the drop is necessary. One variation of this system consists in replacing the piezoelectric crystals by small heating elements behind each nozzle. The drops are ejected following the forming of bubbles of solvent vapor. The volume increase enables the expulsion of the drop. Finally, there is a pulsed inkjet system in which the ink is solid at ambient temperature. The print head thus has to be heated so that the ink liquefies and it can print. This enables rapid drying on a wider range of products than conventional systems.

There now exist new “inkjet” printers capable of producing photographic images of excellent quality. However, they cannot supply good proofs if inferior quality printing paper is used. The choice of printing paper is fundamental for the quality of the obtained image. The printing paper must combine the following properties: high-quality printed image, rapid drying after printing, good dye keeping in time, smooth appearance, and high gloss.

In general, the printing paper comprises a support coated with one or more layers according to the properties required. It is possible, for example, to apply on a support a primary attachment layer, an absorbent layer, an ink dye fixing layer and a protective layer or surface layer to provide the glossiness of the recording element. The absorbent layer absorbs the liquid part of the water-based into composition after creation of the image. Elimination of the liquid reduces the risk of ink migration at the surface. The ink dye fixing layer prevents any dye loss into the fibers of the paper base so as to obtain good color saturation while preventing excess ink that would encourage the increase in size of the printing dots and reduce the image quality. The absorbent layer and fixing layer can also constitute a single ink-receiving layer ensuring both functions. The protective layer is designed to ensure protection against fingerprints and the pressure marks of the printer feed rollers. The ink-receiving layer usually comprises a binder, a receiving agent and various additives. The purpose of the receiving agent is to fix the dyes in the printing paper. The best-known inorganic receivers are colloidal silica or boelimte. For example, the European Patent Applications EP-A-976,571 and EP-A-1,162,076 describe materials for inkjet printing in which the ink-receiving layer contains as inorganic receivers Ludox™ CL (colloidal silica) marketed by Grace Corporation or Dispal™ (colloidal boehmite) marketed by Sasol. However, printing papers comprising an ink-receiving layer containing such inorganic receivers can have poor image stability over time, which is demonstrated by a loss of color density.

To meet the new requirements of the market in terms of photographic quality, printing speed and color stability, it is necessary to offer a new inkjet recording element having the properties as defined above, more particularly good dye keeping properties in time.

### SUMMARY OF THE INVENTION

The new inkjet recording element according to the present invention, comprises a support and at least one ink-receiving layer, and is characterized in that said ink-receiving layer comprises at least one hydrosoluble binder and one polymeric inorganic material based on silicon and aluminum comprising more than 80 moles % of a fibrous aluminosilicate of formula AlₓSi_{y}O_{z} in which the ratio x:y is between 1 and 3, and z is between 2 and 6. Such polymeric material is obtainable by a preparation method that comprises the following steps:
a) treating a mixed aluminum and silicon alcoxide, or a mixed aluminum and silicon precursor, with an aqueous alkali, whilst maintaining the pH between 4 and 6.5, the aluminum concentration being maintained between 5.10⁻⁴ and 10⁻² mol/l and the Al/Si molar ratio being maintained between 1 and 3;
b) heating the mixture obtained in step a) at a temperature below the boiling point of water, in the presence of silanol groups for sufficient time to obtain a complete reaction of forming the polymeric inorganic material; and
c) eliminating the byproducts formed during steps a) and b) from the reaction medium.

The present invention also relates to the use of a polymeric inorganic material as described above as a receiving agent in an ink-receiving layer of an inkjet recording element, said ink-receiving layer also comprising at least one hydrosoluble binder.

The inkjet recording element according to the present invention has improved dye keeping in time compared with the inkjet recording elements available on the market. In particular, an image printed on the recording element according to the present invention has good color stability to ozone and light.

### BRIEF DESCRIPTION OF THE DRAWINGS

FIGS. 1 to 3 represent the percentage of color density loss for a comparative recording elements and a recording element according to the present invention when exposed to ozone, and

FIGS. 4 to 6 represent the percentage of color density loss for a comparative recording element and a recording element according to the present invention when exposed to light.

### DETAILED DESCRIPTION OF TIRE INVENTION

The inkjet recording element according to the present invention comprises firstly a support. This support is selected according to the desired use. It can be a transparent or opaque thermoplastic film, in particular a polyester base film such as polyethylene terephthalate or polymethylmetacrylate; cellulose derivatives, such as cellulose ester, cellulose triacetate, cellulose diacetate; polyacrylates; polyimides; polyamides; polycarbonates; polystyrenes; polyolefines; polysulfones; polyetherimides; vinyl polymers such as polyvinyl chloride; and their mixtures. The support used in the invention can also be paper, both sides of which may be covered with a polyethylene layer. When the support comprising the paper pulp is coated on both sides with polyethylene, it is called Resin Coated Paper (RC Paper) and is marketed under various brand names. This type of support is especially preferred to constitute an inkjet recording element. The side of the support that is used can be coated with a very thin layer of gelatin or another composition to ensure the adhesion of the first layer on the support.

To improve the adhesion of the ink-receiving layer on the support, the support surface can also have been subjected to a preliminary treatment by Corona discharge before applying the ink-receiving layer.

The inkjet recording element according to the invention then comprises at least one ink-receiving layer. This layer comprises at least one hydrosoluble binder. Said hydrosoluble binder can be a hydrophilic polymer such as polyvinyl alcohol, poly(vinyl pyrrolidone), gelatin, cellulose ethers, poly(oxazolines), poly(vinylacetamides), poly(vinyl acetate/vinyl alcohol) partially hydrolised, poly(acrylic acid), poly(acrylamide), sulfonated or phosphated polystyrenes and polyesters, casein, zein, albumin, chitin, dextran, pectin, derivatives of collagen, agar-agar, guar, carragheenane, tragacanth, xanthan and others. Preferably, one uses gelatin or polyvinyl alcohol. The gelatin is that conventionally used in the photographic field. Such a gelatin is described in Research Disclosure, September 1994, No. 36544, part IIA. Research Disclosure is a publication of Kenneth Mason Publications Ltd., Dudley House, 12 North Street, Emsworth, Hampshire PO10 7DQ, United Kingdom. The gelatin can be obtained from SKW and the polyvinyl alcohol from Nippon Gohsei.

According to the present invention, the ink-receiving layer comprises, as receiving agent, at least one polymeric inorganic material based on silicon and aluminum comprising more than 80 moles % of a fibrous aluminosilicate of formula AlₓSi_{y}O_{z} in which the ratio x:y is between 1 and 3, and z is between 2 and 6. According to one embodiment, the polymeric material comprises more than 98 moles % of a fibrous aluminosilicate having the above formula. Such fibrous aluminosilicate polymer is obtainable by a preparation method comprising the following steps:
a) treating a mixed aluminum and silicon alcoxide, or a mixed aluminum and silicon precursor, with an aqueous alkali, whilst maintaining the pH between 4 and 6.5, the aluminum concentration being maintained
b) heating the mixture obtained in step a) at a temperature below the boiling point of water, in the presence of silanol groups for sufficient time to obtain a complete reaction of forming the fibrous aluminosilicate polymer; and
c) eliminating the byproducts formed during steps a) and b) from the reaction medium.

The fibrous aluminosilicate polymer used in the present invention and its preparation method are described in International Patent Application WO 96/13459 hereby incorporated by reference in its entirety. This aluminosilicate polymer has a uniform fibrous structure and a composition characterized by a uniform Al/Si molar ratio.

According to one embodiment described in document WO 96/13459, the mixed aluminum and silicon precursor can be the product of the hydrolysis (i) of one compound selected from the group consisting of is aluminum salts, aluminum alcoxides and aluminum halogenoalcoxides and (ii) at least one compound selected from the group consisting of silicon alcoxides and chloroalcoxides. The aluminum salt can be a halide (e.g. chloride or bromide), a perhalogenate, a sulfate, a nitrate, a phosphate or a carboxylate.

Preferably, the mixed aluminum and silicon precursor is formed in situ by blending an aluminum halide and a silicon alcoxide in an aqueous medium. The alcoxide radical of the silicon compound preferably contains 1 to 5 carbon atoms, such as methoxide, ethoxide, n-propoxide, or i-propoxide. Preferably, tetramethyl or tetraethyl orthosilicate is used.

By the controlled hydrolising of the aluminum salt and silicon alcoxide, the mixed precursor compound is formed and can then be used in step (a) defined above.

The controlled hydrolysis is performed by slowly adding the silicon alcoxide to a freshly prepared aqueous solution of the aluminum salt. In practice, alcoxide, pure or in alcoholic solution, is added drop-by-drop to an aqueous solution of aluminum chloride, aluminum perchlorate, etc. The addition is carried out at room temperature, with moderate stirring, using solutions having an solution of aluminum chloride, aluminum perchlorate, etc. The addition is carried out at room temperature, with moderate stirring, using solutions having an aluminum concentration between 10⁻³ M and 10⁻² M and, advantageously between 5×10⁻³ M and 7×10⁻³ M. This technique is an application of the conventional sol/gel method, described for example in French Patent Application 9203653 or in U.S. Pat. No. 4,122,041.

According to step a) of the preparation method of the fibrous aluminosilicate polymer used in the present invention, the precursor or a mixed aluminum and silicon alcoxide is then put into contact with an alkali in an aqueous or hydro-alcoholic solution. Step (a) must be performed by maintaining the pH between 4 and 6.5 and, preferably between 4.5 and 5.5; the optimal pH depending on the compounds used. If the pH is less than 4, the action of the alkali leads to the non-reversible formation of hydrated alumina, while at a pH greater than 6.5, there is the non-reversible formation of a silica gel.

The alkali is preferably an aqueous solution of sodium or potassium hydroxide, with a concentration between 10⁻² and 10⁻⁴ M and preferably between 5×10⁻³ and 5×10⁻⁴ M. The alkali solution is added to the alcoxide or precursor at a rate of between 0.1 and 10 mmoles/hour and, advantageously between 1 and 10 mmoles/hour. The total quantity of alkali added in moles is between 2 and 3 times and, preferably, between 2.3 and 2.5 times the quantity of aluminum. The aluminum concentration is maintained between 5.10 and 10⁻² mol/l and the Al/Si molar ratio is maintained between 1 and 3, and preferably between 1.5 and 2.5.

After the addition of the alkali, step b) of the preparation method of the fibrous aluminosilicate polymer useful in the present invention consists in heating the mixture resulting from the previous step a) in set temperature conditions, in the presence of silanol groups, until the complete condensation reaction. According to one embodiment, in step (b), the heating is to a temperature between about 70° C. and 98° C. The condensation reaction is taken as complete when by dialysis, it can be checked that this medium no longer contains any other ions than those coming from the alkali, i.e. ions Na⁺ or K⁺; all the other ions, i.e.

An important characteristic of the preparation method of the fibrous aluminosilicate polymer useful in the present invention is that this heating step is carried out in the presence of silanol groups, for example, preferably in a divided form, comprising surface silanol groups SiOH.

The tests carried out showed more especially that the step (b) reaction described above develops to form a silico-aluminate with uniform fibrous structure, when the content of accessible silanol groups (SiOH), i.e. on the surface of a substrate, is at least about four silanol groups per μm² surface area of substrate, which corresponds to a number ratio of Al involved in the reaction: silanol number, less than about 2.25×10¹⁰ and advantageously less than 1.0×10¹⁰.

Then, step c) of the preparation method of the fibrous aluminosilicate polymer useful in the present invention consists in eliminating from the reaction medium the byproducts formed during steps a) and b), such as the residual ions essentially coming from the alkali used in step a). The residual ions can be eliminated by washing, by dialysis or by ultrafiltration. The fibrous aluminosilicate polymer resulting from step c) can then be isolated from its solution by lyophilisation or concentrated by centrifugation.

The Al:Si atomic ratio, calculated on the starting products is between 1 and 3 and, preferably between 1.5 and 2.5. In the final product, the Al:Si atomic ratio is more or less between the same values.

When the operating conditions of the preparation method of fibrous aluminosilicate polymer useful in the present invention are not used, an heterogeneous product comprising up to 60 percent mole of hydrated alumina (boehmite) is obtained in aggregate form.

Part of the silicon present in the fibrous aluminosilicate polymer used in the present invention can be replaced by a metal chosen in the class containing titanium, zirconium or tin. Such a polymer is described in U.S. Pat. No. 6,027,702 hereby incorporated by reference in its entirety. The preparation method for this polymer is the same as the method described above, except for the fact that to the hydrolisable aluminum and silicon compounds are added a hydrolisable compound of the metal selected from the group consisting of titanium, zirconium and tin (halides or alcoxides) and the mixture is hydrolised at controlled pH. The resulting product is then subject to heating to a temperature less than 100° C. in the presence of silanol groups.

The ink-receiving layer comprises between 5 percent and 95 percent by weight of fibrous aluminosilicate polymer compared with the total weight of the ink-receiving layer in the dry state.

To produce the coating composition intended to be coated onto the support to constitute the ink-receiving layer of the recording element described above, the hydrosoluble binder is diluted in water to adjust its viscosity and facilitate its coating. The composition then has the form of an aqueous solution or a dispersion containing all the necessary components.

The composition can also comprise a surfactant to improve its coating properties. The composition can be layered on the support according to any appropriate coating method, such as blade, knife or curtain coating. The composition is applied with a thickness approximately between 20 and 300 μm in the wet state, preferably between 100 and 300 μm and preferably 200 μm. The composition forming the ink-receiving layer can be applied to both sides of the support. It is also possible to provide an antistatic or anti-winding layer on the back of the support coated with the ink-receiving layer.

The inkjet recording element according to the invention can comprise, besides the ink-receiving layer described above, other layers having another function, arranged above or below said ink-receiving layer. The ink-receiving layer as well as the other layers can comprise all the other additives known to those skilled in the art to improve the properties of the resulting image, such as UV ray absorbers, optical brightening agents, antioxidants, plasticizers, etc.

With inkjet recording element according to the present invention, the printed image has good dye keeping in time, shown by its stability to ozone and light. The recording element according to the invention can be used for any type of inkjet printer as well as for all the inks developed for this technology.

According to the present invention, the use of a polymeric inorganic material as described above as a receiving agent in an ink-receiving layer of an inkjet recording element enables an image printed on said element to be obtained that is stable to light and ozone.

The following examples illustrate the present invention without however limiting its scope.

### 1) Preparation of the Polymeric Inorganic Aluminosilicate Material

A fibrous aluminosilicate polymer used in the present invention is prepared. Such an aluminosilicate polymer is described in Patent Application WO 96/13459.

83.5 mmoles of tetramethoxysilicon Si(OMe)₄ were added to 5000 ml of osmosed water. The mixture was stirred at room temperature for 1 hour, then this solution was added to a solution of 156 mmoles of aluminum trichloride AlCl₃,6H₂O in 5000 ml of osmosed water.

The mixture was stirred vigorously for 1 hour, then to the colorless solution was added a solution of NaOH 1M until a pH of 4.5 was obtained. A cloudy solution was obtained that was stirred overnight. The pH was adjusted to 6.8 with NaOH 1M. A gel was obtained that was centrifuged for 20 minutes at 3200 rpm.

A white gel was recovered that was dissolved with 25 cm³ of a 50:50 mixture of hydrochloric acid M and acetic acid 2M. The volume of the solution was made up to 5 liters.

The solution obtained above was diluted in 11 liters of osmosed water and heated to a temperature between 95° C. and 100° C. for five days in a glass container. The resulting product after heating was filtered by ultrafiltration using an ultrafiltration membrane with a cut-off of 20,000, marketed by Osmonics®, with a flow rate of 550 ml/min. A clear solution was obtained, with high viscosity and having an Al/Si molar ratio of 1.8.

### 2) Preparation of Coating Compositions Constituting an Ink-Receiving Layer Coated on a Support

As hydrosoluble binder, polyvinyl alcohol was used (Gohsenol™ GH23 marketed by Nippon Gohsei) diluted to 9 percent in osmosed water. Composition A comprised as receiving agent the fibrous aluminosilicate polymer prepared according to the synthesis described in paragraph 1.

The coating composition A was obtained by mixing:
84.9 g osmosed water
13.5 g fibrous aluminosilicate polymer (dry matter)
1.6 g polyvinyl alcohol at 9 percent (dry matter).
   For comparison, a coating composition B was prepared comprising as receiving agent dihydrated calcium sulfate marketed by Prolabo.
   The coating composition B is obtained by mixing:
87.7 g osmosed water
10.7 g calcium sulfate (dry matter)
1.6 g polyvinyl alcohol at 9 percent (dry matter).

### 3) Preparation of Inkjet Recording Elements

To do this, a Resin Coated Paper type support was placed on a coating machine, first coated with a very thin gelatin layer, and held on the coating machine by vacuum. This support was coated with a composition as prepared according to paragraph 2 using a blade. The wet thickness was 200 μm. Then, it was left to dry at ambient air temperature (21° C.).

The resulting recording elements correspond to the examples shown in Table I below giving the receiving agent used in the ink-receiving layer:

TABLE I

| Recording | | Receiving agent in the |
|---|---|---|
| element | Composition | ink-receiving layer |
| Ex. 1 (inv.) | A | Fibrous aluminosilicate |
| Ex. 2 (comp.) | B | Calcium sulfate |

### 4) Evaluation of Dye Keeping Properties in Time

To evaluate the dye keeping properties in time, a dye fading test by exposure to ozone and light was performed for each resulting recording element. To do this, targets, comprising four colors (black, yellow, cyan and magenta) were printed on each recording element using a KODAK PPM 200 printer and related ink, an Epson SP890 printer and related ink or a Hewlett Packard HP 5550 printer and related ink. The targets were analyzed using a GretagMacbeth Spectrolino spectrophotometer that measured the intensity of the various colors. Then the recording elements of examples 1 and 2 were placed in the dark in a room with controlled ozone atmosphere (60 ppb) for three weeks. Other recording elements in compliance with examples 1 and 2 were exposed to a light of 50 Klux for three weeks. For this, the printed targets were placed under a sheet of Plexiglas® 6 mm thick and totally transparent to the emission spectra of the neon tubes used (Osram Lumnilux® FQ 80 W/840 Cool White), in order to minimize atmospheric oxidation phenomena.

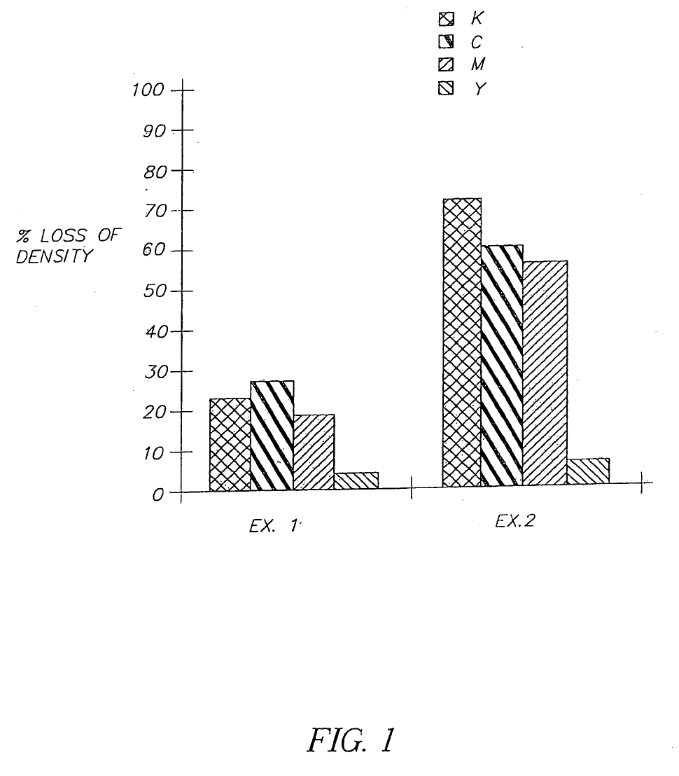

FIG. 1 represents the percentage of density loss observed for the maximum density for the four colors of the target after three weeks for examples 1 and 2 printed using the Kodak PPM 200 printer and exposed to ozone. Letters K, C, M and Y represent the colors black, cyan, magenta and yellow respectively.

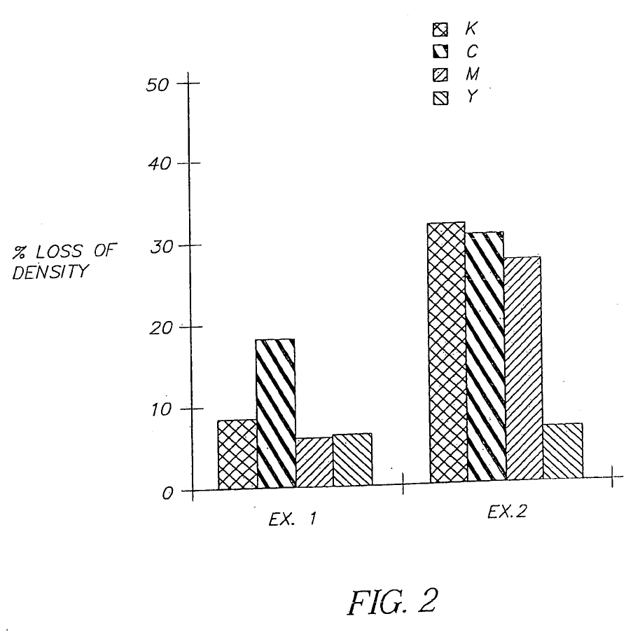

FIG. 2 represents the percentage of density loss observed for the maximum density for the four colors of the target after three weeks for examples 1 and 2 printed using the Epson SP890 printer and exposed to ozone.

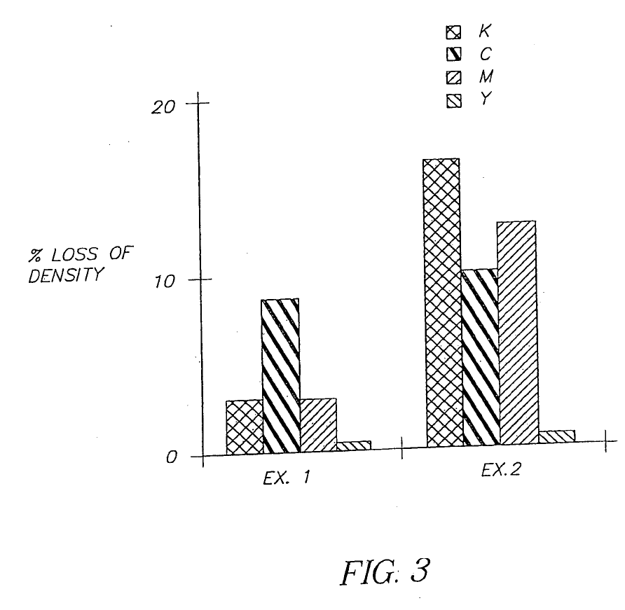

FIG. 3 represents the percentage of density loss observed for the original density of 0.5 for the four colors of the target after three weeks for examples 1 and 2 printed using the HP 5550 printer and exposed to ozone.

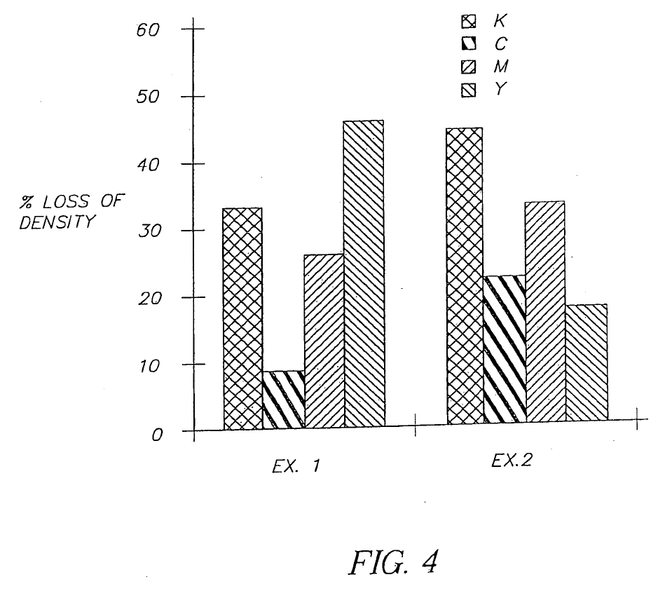

FIG. 4 represents the percentage of density loss observed for the maximum density for the four colors of the target after three weeks for examples 1 and 2 printed using the Kodak PPM 200 printer and exposed to light.

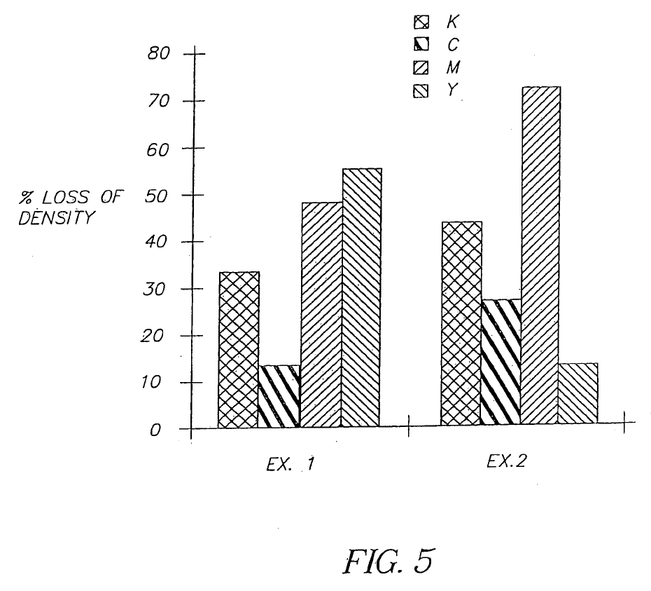

FIG. 5 represents the percentage of density loss observed for the maximum density for the four colors of the target after three weeks for examples 1 and 2 printed using the Epson SP890 printer and exposed to light.

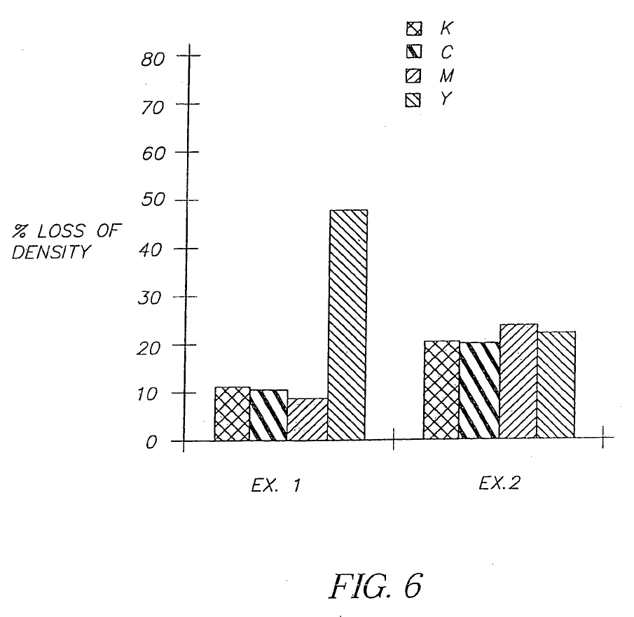

FIG. 6 represents the percentage of density loss observed for the maximum density for the four colors of the target after three weeks for examples 1 and 2 printed using the HP 5550 printer and exposed to light.

It may be seen that the recording elements according to the invention have very good dye keeping properties in time.

1) An inkjet recording element, comprising a support and at least one ink-receiving layer, wherein said ink-receiving layer comprises at least one hydrosoluble binder and one polymeric inorganic material based on silicon and aluminum comprising more than 80 moles % of a fibrous aluminosilicate of formula AlₓSi_{y}O_{z} in which the ratio x:y is between 1 and 3, and z is between 2 and 6.

2) The recording element according to claim 1, wherein said polymeric inorganic material is obtainable by a preparation method that comprises the following steps:
a) treating a mixed aluminum and silicon alcoxide, or a mixed aluminum and silicon precursor, with an aqueous alkali, whilst maintaining the pH between 4 and 6.5, the aluminum concentration being maintained between 5.104 and 1 mol/l and the Al/Si molar ratio being maintained between 1 and 3;
b) heating the mixture obtained in step a) at a temperature below the boiling point of water, in the presence of silanol groups for sufficient time to obtain a complete reaction of forming the polymeric inorganic material; and
c) material the byproducts formed during steps a) and b) are eliminated from the reaction medium.

3) The recording element according to claim 1, wherein part of the silicon is replaced by a metal selected from the group consisting of titanium, zirconium and tin.

4) The recording element according to claim 1, wherein the alkali of step a) to prepare the aluminosilicate polymer is selected from the group consisting of sodium and potassium hydroxide.

5) The recording element according to claim 1, wherein the amount of silanol groups used in step b) corresponds to a ratio between aluminum atoms and silanol groups of less than 2.25.10¹⁰.

6) The recording element according to claim 5, wherein the amount of silanol groups used in step b) corresponds to a ratio between aluminum atoms and silanol groups of less than 1.0.10¹⁰.

7) The recording element according to claim 1, wherein the Al/Si molar ratio is between 1.5 and 2.5.

8) The recording element according to claim 1, wherein in step a) the pH is maintained at between 4.5 and 5.5.

9) The recording element according to claim 1, wherein in step b) the heating is at a temperature between about 70° C. and 98° C.

10) The recording element according to claim 1, wherein the mixed aluminum and silicon precursor is the product of the hydrolysis (i) of one compound selected from the group consisting of aluminum salts, aluminum alcoxides and aluminum halogenoalcoxides and (ii) at least one compound selected from the group consisting of silicon alcoxides and chloroalcoxides.

11) The recording element according to claim 10, wherein said mixed aluminum and silicon precursor is the product of the hydrolysis (i) of an aluminum halide and (ii) a silicon alcoxide.

12) The recording element according to claim 11, wherein said silicon alcoxide is tetramethyl orthosilicate or tetraethyl orthosilicate.

13) The recording element according to claim 1, wherein said ink-receiving layer comprises between 5 percent and 95 percent by weight of said polymeric inorganic material compared with the total weight of the dry receiving layer.

14) The recording element according to claim 1, wherein said hydrosoluble binder is gelatin or polyvinyl alcohol.

15) The use of a polymeric inorganic material based on silicon and aluminum comprising more than 80 moles % of a fibrous aluminosilicate of formula AlₓSi_{y}O_{z} in which the ratio x:y is between 1 and 3, and z is between 2 and 6 as receiving agent in an ink-receiving layer of an inkjet recording element, said ink-receiving layer comprising at least one hydrosoluble binder.
